(19) United States
(12) Patent Application Publication
(10) Pub. No.: US 2008/0012443 A1
(43) Pub. Date: Jan. 17, 2008

(54) MOTOR AND DISK DRIVE INCLUDING THE SAME

(75) Inventors: Takehito TAMAOKA, Kyoto (JP); Shingo SUGINOBU, Kyoto (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: NIDEC CORPORATION, Kyoto (JP)

(21) Appl. No.: 11/764,966

(22) Filed: Jun. 19, 2007

(30) Foreign Application Priority Data
Jun. 22, 2006 (JP) 2006-172402

(51) Int. Cl. H02K 1/22; G11B 5/52

(52) U.S. Cl. 310/179; 360/86

(57) ABSTRACT

A base plate serving as a base portion of a motor has a plurality of coil-receiving portions in regions corresponding to a plurality of teeth and coils, respectively. Each coil-receiving portion receives a lower portion of a corresponding coil. The axial thickness of the base plate and that of the motor can be reduced by forming the base plate by pressing. The base plate is provided with a projection formed thereon. The projection extends generally in a direction perpendicular to a center axis of the motor between the coil-receiving portions. The projection is arranged to cross a line connecting closest portions of two coil-receiving portions to each other. Thus, a portion of the base plate having the lowest strength is reinforced and therefore the strength of the base plate is increased.

### BACKGROUND OF THE INVENTION

1. Field of the Invention

The present invention relates to an electric motor and a disk drive including the same.

2. Description of the Related Art

Disk drives such as hard disk drives include spindle motors (hereinafter, simply referred to as motors) which rotate disk-shaped storage media. The disk drives are incorporated in many portable music players and the like, and are therefore required to have a large capacity and be small and thin. In accordance with this, the motors as driving sources of the disk drives are also required to be small and thin.

The motors can be made thin, for example, by reducing the thickness of a base portion in a motor which supports various components of the motor. However, as the thickness of the base portion is reduced, the strength thereof is lowered and it is going to be more likely that the base portion is deformed by impact applied from the outside and resonance with various vibrations. In order to avoid this problem, there are various techniques known for achieving reduction in the thickness of the base portion and increase in the strength of the base portion at the same time.

Japanese Patent No. 3079536 describes a housing for a spindle motor. The housing is provided with a circumferential groove for receiving a plurality of coils of an armature of the spindle motor in a bottom surface thereof. A plurality of projections are radially provided on an inner bottom surface of the circumferential groove between the coils so as to extend to an outer periphery of the armature. With this structure, the strength of the housing is increased.

Japanese Utility Publication No. 5-9178 discloses a metal base printed board on which a bearing housing is formed by drawing. Ribs are formed by drawing on a rear surface of the printed board, i.e., an opposite surface to the surface on which a stator and the bearing housing are provided. The ribs are radially arranged about the bearing housing. With this structure, the strength of the printed board is increased.

Japanese Patent Publication No. 2002-315254 describes that a base member of a motor is formed by pressing and has a plurality through holes for receiving stator coils. Generally rectangular ribs made of resin are formed by outsert molding between the through holes. With this structure, the strength of the base member is increased. Similar ribs (columns) are disclosed in Japanese Patent Publication No. 2003-299301. In this publication, the ribs or columns are formed integrally with the base member by aluminum die-casting.

Furthermore, Japanese Patent Publication No. 2005-245134 describes an attachment plate for a motor in a motor unit. A rib is formed by pressing on a base plate of the attachment plate so as to project from a rear surface of the base plate. The base plate has an opening for reducing the weight of the base plate separately from a hole into which the motor is attached. The rib is arranged along an edge of the opening. With this structure, a certain level of the strength of the base plate is ensured.

However, in the motors of Japanese Patent Publication No. 2003-299301 and Japanese Patent No. 3079536, the base portion is formed by die-casting. Therefore, reduction in the thickness of the base portion is limited. In the motors of Japanese Utility Publication No. 5-9178 and Japanese Patent Publication No. 2005-245134, the ribs are formed on the rear surface of the base portion, i.e., on the opposite side of the base portion to the side where a bearing and an armature are attached. Thus, the ribs increase the thickness of the base portion by the thickness (height) thereof. Furthermore, when the ribs are formed by outsert molding as in Japanese Patent Publication No. 2002-315254, a process for manufacturing the base portion is complicated.

### SUMMARY OF THE INVENTION

According to preferred embodiments of the present invention, an electric motor includes: a stationary portion including an armature and a base portion to which the armature is attached; and a rotor portion supported by a bearing assembly in a rotatable manner about a center axis relative to the stationary portion. The rotor portion includes a magnet which interacts with the armature to generate a torque about the center axis. The armature of the stationary portion includes a stator core having a plurality of teeth radially disposed about the center axis. The armature also includes a plurality of coils formed by winding a conductive wire around the teeth. The base portion has a plurality of coil-receiving portions in regions corresponding to the coils, respectively. Each coil-receiving portion receives a portion of a corresponding one of the coils. The base portion has a projection projecting toward the armature. The projection is arranged between adjacent two coil-receiving portions, extends generally in a direction perpendicular to or substantially perpendicular to the center axis, and crosses a line connecting closest portions of the adjacent two coil-receiving portions to each other.

Other features, elements, advantages and characteristics of the present invention will become more apparent from the following detailed description of preferred embodiments thereof with reference to the attached drawings.

### BRIEF DESCRIPTION OF THE DRAWINGS

FIG. 1 shows an internal structure of a disk drive according to a first preferred embodiment of the present invention.

FIG. 2 is a vertical cross-sectional view of a motor in the disk drive of FIG. 1.

FIG. 3 is a plan view of a stator core of the motor of FIG. 2.

FIG. 4 is a plan view of a base plate of the motor of FIG. 2.

FIG. 5 is a vertical cross-sectional view of a motor according to a second preferred embodiment of the present invention.

FIG. 6 is a plan view of a base plate of the motor of FIG. 5.

FIG. 7 is a plan view of a base plate according to a third preferred embodiment of the present invention.

FIG. 8 is a vertical cross-sectional view of a motor according to a fourth preferred embodiment of the present invention.

FIG. 9 is a plan view of a base plate according to another preferred embodiment of the present invention.

FIG. 10 is a plan view of a base plate according to still another preferred embodiment of the present invention.

FIG. 11 is a plan view of a base plate according to further another preferred embodiment of the present invention.

FIG. 12 is a plan view of a base plate according to further another preferred embodiment of the present invention.

FIG. 13 is a plan view of a base plate according to further another preferred embodiment of the present invention.

FIG. 14 is a cross-sectional view of a portion of the base plate shown in FIG. 13.

### DETAILED DESCRIPTION OF PREFERRED EMBODIMENTS

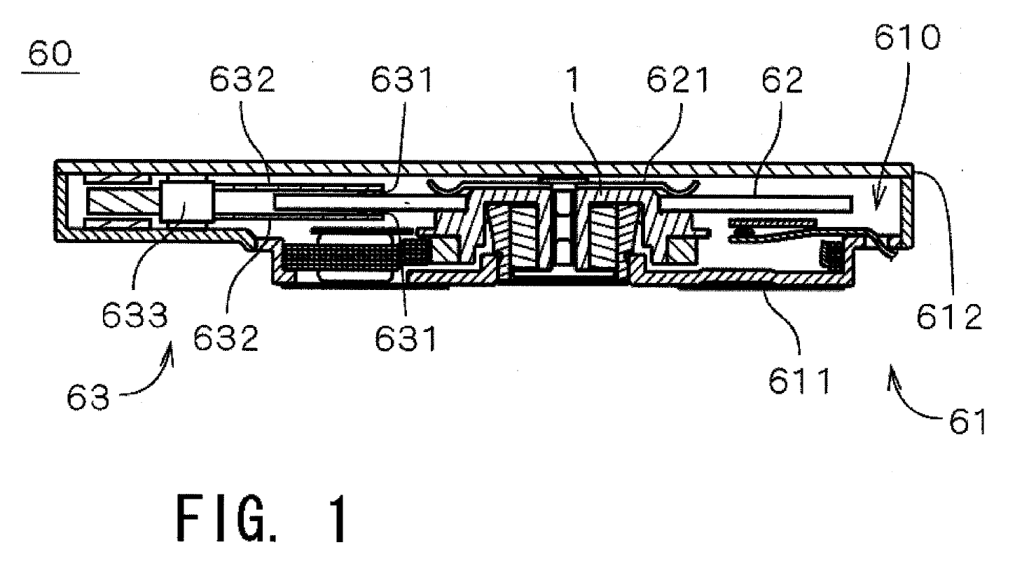

Referring to FIGS. 1 through 14, preferred embodiments of the present invention will be described in detail. It should be noted that in the explanation of the present invention, when positional relationships among and orientations of the different components are described as being up/down or left/right, ultimately positional relationships and orientations that are in the drawings are indicated; positional relationships among and orientations of the components once having been assembled into an actual device are not indicated. Meanwhile, in the following description, an axial direction indicates a direction parallel to a rotation axis, and a radial direction indicates a direction perpendicular to the rotation axis.

### First Preferred Embodiment

FIG. 1 is a vertical cross-sectional view of a disk drive 60 including an electric spindle motor 1 (hereinafter, simply referred to as a motor) according to a first embodiment of the present invention. For example, the disk drive 60 is a hard disk drive. The disk drive 60 includes: a disk-shaped storage medium (hereinafter, simply referred to as a disk) 62 in the form of a generally circular plate, capable of storing information; an access portion 63 carrying out at least one of reading information from and writing information on the disk 62; the electric motor 1 for holding and rotating the disk 62; and a housing 61 defining an internal space 610 in which the disk 62, the access portion 63, and the motor 1 are accommodated. In this preferred embodiment, the disk 62 is a 1.8-inch disk, for example.

As shown in FIG. 1, the housing 61 includes a first housing member 611 and a second housing member 612. The first housing member 611 is a generally box-shaped member with no lid and has an opening at its upper end. The motor 1 and the access portion 63 are accommodated inside the first housing member 1 and are mounted on the bottom of the first housing member 1. The second housing member 612 is a generally plate-like member and closes the opening of the first housing member 611 to form the internal space 610. The housing 61 is formed by joining the first and second housing members 611 and 612. The internal space 610 in the housing 61 is very clean, i.e., contains very few dust or dirt particles.

The disk 62 is placed on the motor 1 and is secured to the motor 1 with a damper 621. The access portion 63 includes a head 631 which is brought close to the disk 62 to carry out at least one of reading information from and writing information on the disk 62 magnetically, an arm 632 supporting the head 631, and a head moving portion 633 which moves the arm 632 to move the head 631 relative to the disk 62 and the motor 1. With this configuration, the head 631 is brought very close to the disk 62 which is rotating, and makes an access to a desired position on the disk 62. In this manner, information is read on or written from the disk 62.

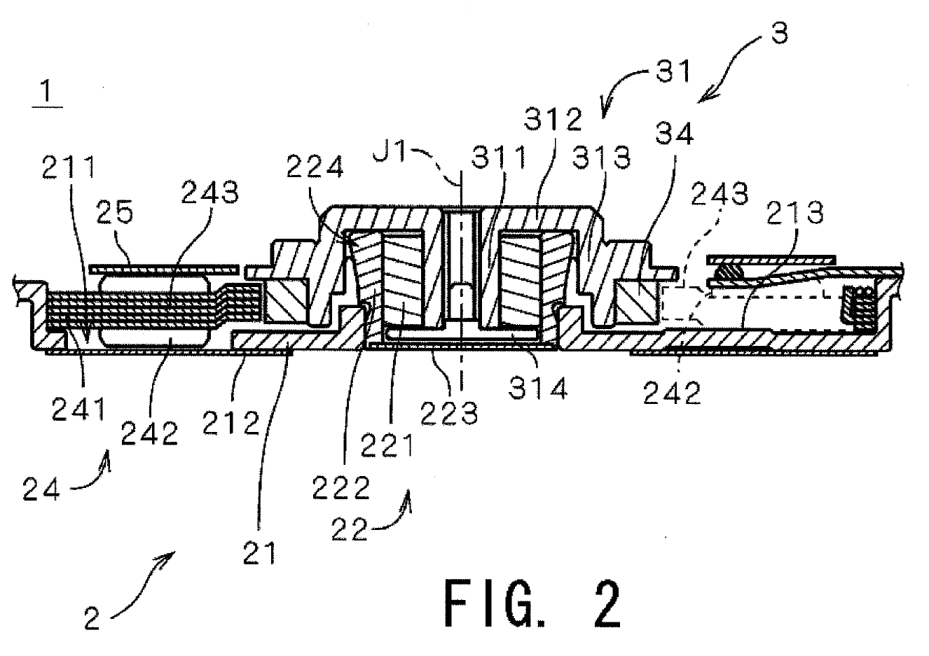

FIG. 2 is a vertical cross-sectional view of the motor 1 used for rotating the disk 62 in the disk drive 60, taken along a plane including a center axis J1 of the motor 1 (which also serves as a center axis of an armature 24 described later). In FIG. 2, the structure behind the above plane is partly shown with broken line.

In this preferred embodiment, the motor 1 is an inner rotor type motor, as shown in FIG. 2. The motor 1 includes a stationary portion 2 as a fixed assembly and a rotor portion 3 as a rotating assembly. The rotor portion 3 is supported in a rotatable manner about the center axis J1 of the motor 1 relative to the stationary portion 2 by a bearing assembly which uses a dynamic pressure of lubricating oil serving as operating fluid. In the following description, the rotor portion 3 side in an axial direction which is parallel to the center axis J1 is referred to as an upper side and the stationary portion 2 side in the axial direction is referred to as a lower side. However, it is not necessary that the center axis J1 is parallel to a direction of gravity.

The rotor portion 3 includes a rotor hub 31 holding other components of the rotor portion 3, and a magnet 34 attached to the rotor hub 31. The magnet 34 is used for generating a magnetic field and is disposed about the center axis J1. In this preferred embodiment, the rotor hub 31 is a jointless member made of stainless, for example. The rotor hub 31 includes: a shaft 311 which is hollow and generally cylindrical about the center axis J1 and extends downwardly (i.e., toward the stationary portion 2); a plate portion 312 in the form of a generally circular plate perpendicular to or substantially perpendicular to the center axis J1, which extends from an upper end of the shaft 311; and a cylindrical portion 313 which is hollow and generally cylindrical and extends downwardly from an outer periphery of the plate portion 312. A thrust plate 314 in the form of a generally circular plate is attached to a lower end of the shaft 311.

The stationary portion 2 includes: a base plate 21 which forms a portion of the first housing member 611 (see FIG. 1) and serves as a base portion for supporting other components of the stationary portion 2; a sleeve unit 22 in the form of a hollow, generally cylindrical member which forms a portion of the bearing assembly for supporting the rotor portion 3 in a rotatable manner; an armature 24 attached to the base plate 21 radially outside the sleeve unit 22; and a magnetic shield plate 25 in the form of a thin plate arranged above the armature 24. The magnetic shield plate 25 shields electromagnetic noises from the armature 24.

The base plate 21 is integrally formed with other portions of the first housing member 611, for example, by pressing a plate-like member. Exemplary materials of the base plate 21 are aluminum, aluminum alloy, magnetic or non-magnetic stainless steel such as SUS303, SUS304, and SUS420 in Japanese Industrial Standard (JIS), cold rolled steel sheet such as SPCC in JIS, and electrolytic zinc-coated steel sheet such as SECE in JIS.

The sleeve unit 22 is provided with a hollow, generally cylindrical sleeve 221 centered on the center axis J1. Into the sleeve 221 is inserted the shaft 311 of the rotor portion 3. In this preferred embodiment, the sleeve 221 is made of porous material. A hollow, generally cylindrical sleeve housing 222 is attached to the outer surface of the sleeve 221. The sleeve housing 222 has a function of retaining lubricating oil with which the sleeve 221 is impregnated. A seal cap 223 in the form of a generally circular plate is provided to close a lower opening of the sleeve housing 222. The sleeve 221, the sleeve housing 222, and the seal cap 223 form together the sleeve unit 22. The lower portion of the sleeve unit 22 is press-fitted into an opening formed at the center of the base plate 21, thereby being secured to the base plate 21.

The armature 24 includes a stator core 241 having a plurality of teeth 243 and a plurality of coils 242 formed by winding a conductive wire around the teeth 243. The stator core 241 interacts with the magnet 34 arranged on the center-axis side of the stator 24, thereby generating a rotational force (torque) about the center axis J1. In the armature 24, the teeth 243 are bent in such a manner that center-axis side ends thereof face the outer side surface of the magnet 34 in a radial direction perpendicular to or substantially perpendicular to the center axis J1. Such bending structure of the teeth 243 enables efficient generation of the torque between the armature 24 and the magnet 34.

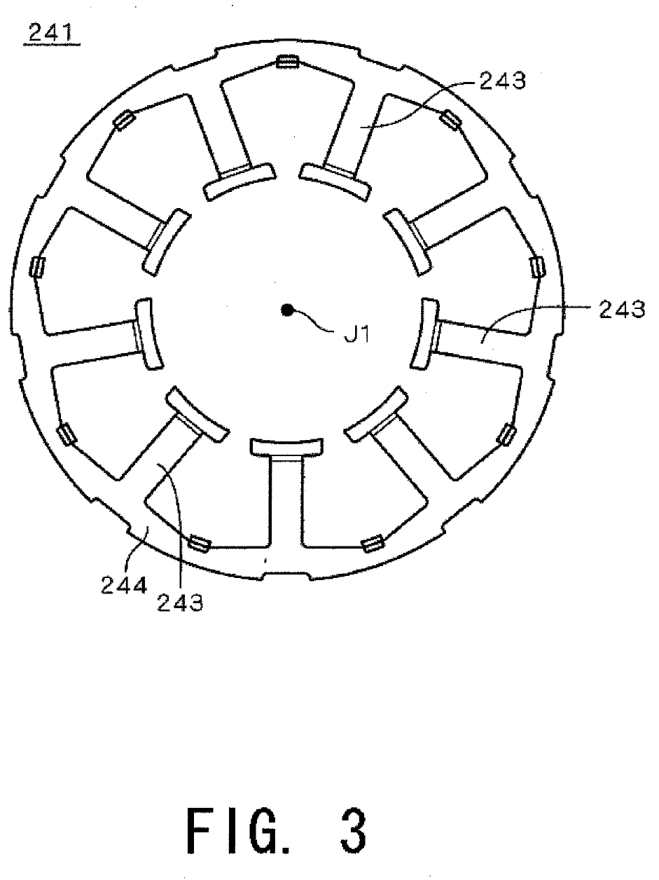

FIG. 3 is a plan view of the stator core 241. As shown in FIG. 3, the stator core 241 includes a plurality of teeth 243 radially disposed about the center axis J1 and a ring-shaped core back 244 supporting the teeth 243. The teeth 243 are connected at their radially outer ends to the core back 244 and extend in the radial direction toward the center axis J1. In this preferred embodiment, nine teeth 243 are provided. Referring to FIG. 2, the stator core 241 is formed by a plurality of thin core plates which are stacked. In this preferred embodiment, five core plates are stacked to form the stator core 241. For example, each core plate is formed by stamping out a thin silicon steel plate by pressing. In each core plate of the stator core 241, portions serving as portions of the teeth 243 and a portion serving as a portion of the core back 244 are integrally formed with each other. Thus, the teeth 243 and the core back 244 are magnetically connected to each other.

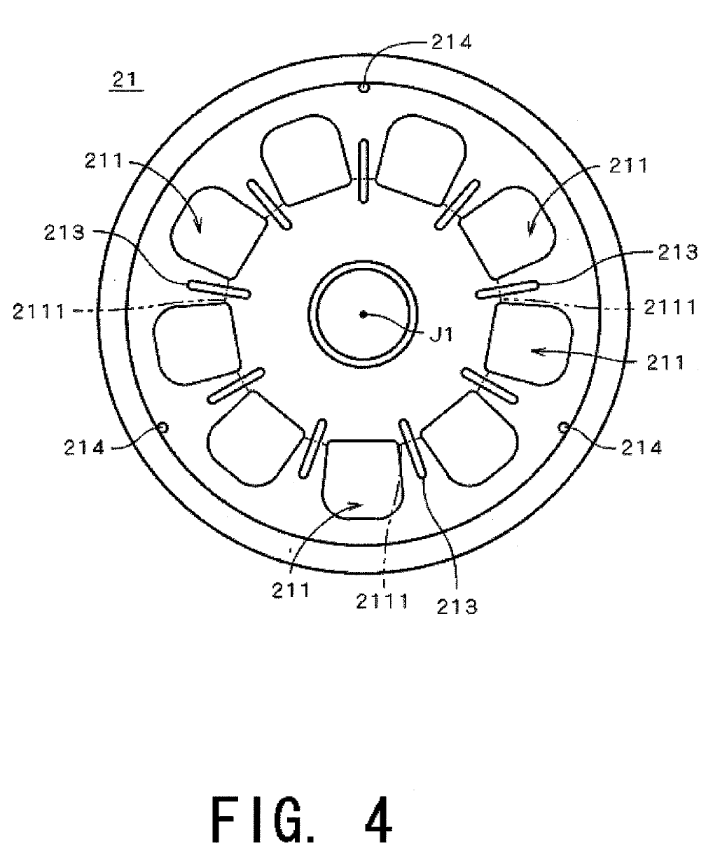

FIG. 4 is a plan view of the base plate 21. As shown in FIG. 4, the base plate 21 has a plurality of holes 211 formed through the base plate 21 in the axial direction. The holes 211 are arranged around the opening into which the sleeve unit 22 (see FIG. 2) is press-fitted. The holes 211 are formed in regions above each of which the tooth 243 and the coil 242 (see FIG. 3) are provided. In this preferred embodiment, nine holes 211 are provided. It is preferable that the axial thickness of the base plate 21 around each hole 211 be approximately 0.1 mm or more from a viewpoint of preventing deformation of the base plate 21 caused by vibration during an operation of the motor 1 and be approximately 1 mm or less from a viewpoint of making the motor 1 slim in the axial direction. In this preferred embodiment, the base plate 21 has an axial thickness of approximately 0.6 mm around each hole 21. In a disk drive provided with a one-inch disk-shaped storage medium, for example, the axial thickness of the base plate 21 around each hole 21 is approximately 0.4 mm.

Since the holes 21 are provided in the base plate 21, lower portions of the coils 242 do not project below the lower surface of the base plate 21 but are received in the corresponding holes 211, as shown in FIG. 2. Thus, the size of the motor 1 in the axial direction can be reduced without reducing the base plate 21 too much.

In the stationary portion 2, the holes 211 are filled with adhesive, so that the coils 242 received in the holes 211 are secured and the holes 211 are sealed. Moreover, as shown in FIG. 2, the base plate 21 is provided with a seal member 212 which closes the holes 211 from the opposite side of the base plate 21 to the side where the armature 24 is arranged. That is, the seal member 212 closes the holes 211 from below, as shown in FIG. 2. It is preferable that the seal member 212 be a thin, generally flat member like a thin plate or a sheet. For example, an identification plate or a flexible circuit board can be used as the seal member 212. In this preferred embodiment, the seal member 212 is generally annular about the center axis J1 and is bonded to the lower surface of the base plate 21 with adhesive, for example.

Referring to FIG. 4, the base plate 21 is provided with ribs 213. Each rib 213 is provided between adjacent two of the holes 211 and is formed by a projection projecting from the upper surface of the base plate 21 upwardly in the axial direction (i.e., toward the armature 24 in FIG. 2). In this preferred embodiment, the rib 213 is provided between every adjacent two holes 211. That is, nine regions are formed between nine holes 211 and nine ribs 213 are provided in those regions in this preferred embodiment. The ribs 213 are integrally formed with the base plate 21 when the base plate 21 is formed by pressing. In this preferred embodiment, the ribs 213 are formed prior to formation of the holes 211.

Each rib 213 extends straight generally parallel to the radial direction with respect to the center axis J1 and has a certain width over its entire length. The rib 213 crosses a line 2111 connecting closest portions of adjacent holes 211 to each other, shown with chain double-dashed line in FIG. 4, generally perpendicularly thereto. A center-axis side end, i.e., an inner end of each rib 213 is located outside the outer side surface of the magnet 34 of the rotor portion 3 in the radial direction. Moreover, the center-axis side end of the rib 213 is located between center-axis side ends of adjacent teeth 243, when seen in the axial direction (see FIG. 3). On the other hand, the other ends of the ribs 213, i.e., radially outer ends of the ribs 213 are located on a circle which is centered on the center axis J1 and passes through the centers of the holes 211 or portions near the centers of the holes 211 in the radial direction. In this preferred embodiment, the height of the ribs 213 from the upper surface of the base plate 21 in the axial direction is 0.1 mm.

Referring to FIG. 4, the base plate 21 is provided with armature supporting portions 214 which project upwardly in the axial direction from the upper surface of the base plate 21. In this preferred embodiment, three armature supporting portions 214 are arranged on a circle centered on the center axis J1 regularly, i.e., at regular angular intervals. The armature supporting portions 214 are in contact with the lower surface of the core back 244 of the armature 24 (see FIG. 3) attached to the base plate 21, thereby supporting the armature 24 from below. In this preferred embodiment, the armature supporting portions 214 are integrally formed with other portions of the base plate 21 by pressing, like the ribs 213.

In the motor 1 shown in FIG. 2, gaps are formed between the lower surface of the plate portion 312 of the rotor hub 31 and the upper end surface of the sleeve housing 222, between the inner side surface of the sleeve 221 and the outer side surface of the shaft 311, between the lower end surface of the sleeve 221 and the upper surface of the thrust plate 314, between the lower surface of the thrust plate 314 and the upper surface of the seal cap 223, and between the outer side surface of a flange portion 224 of the sleeve housing 222 and the inner side surface of the cylindrical portion 313 of the rotor hub 31. That is, those gaps are formed between the rotor hub 31 and the sleeve unit 22. Those gaps are continuously filled with lubricating oil, so that a bearing assembly is formed which supports the rotor portion 3 in a rotatable manner about the center axis J1 relative to the stationary portion 2.

The outer side surface of the flange portion 224 of the sleeve housing 222 is inclined with respect to the center axis J1 in such a manner that an outer diameter of the flange portion 224 gradually decreases as it moves axially downwardly. On the other hand, the inner side surface of the cylindrical portion 313 of the rotor hub 31, which faces the outer side surface of the flange portion 224 in the radial direction, is constant. Thus, a meniscus interface of the lubricating oil is formed in the gap between the flange portion 224 and the cylindrical portion 313 because of capillary action and surface tension, so that a taper seal is formed. Therefore, this gap serves as an oil buffer and prevents leak of the lubricating oil.

The lower end surface of the sleeve 221 is provided with a groove for generating a pressure of lubricating oil, which acts toward the center axis J1, while the rotor portion 3 is rotating. The groove has a spiral shape, for example. Thus, the lower end surface of the sleeve 221 and the upper surface of the thrust plate 314 opposed thereto form together a thrust dynamic pressure bearing. Moreover, at least one of surfaces of the shaft 311 and the sleeve 211 opposed to each other is provided with a groove for generating a dynamic pressure of lubricating oil. For example, grooves having a herringbone shape are formed on the inner side surface of the sleeve 221 in upper and lower regions in the axial direction. Thus, those opposed surfaces of the shaft 311 and the sleeve 211 form together a radial dynamic pressure bearing.

In the motor 1, the rotor portion 3 is supported in a non-contact manner via lubricating oil by the bearing assembly using a dynamic pressure of the lubricating oil. Therefore, it is possible to rotate the rotor portion 3 and the disk 62 mounted on the rotor portion 3 with high precision and low noises.

As described aboye, the axial thickness of the base plate 21 and that of the motor 1 can be reduced because the base plate 21 is formed by pressing. Moreover, in the motor 1 of this preferred embodiment, the rib 213 extending in the radial direction is formed between adjacent holes 211 and is arranged to cross the line 2111 connecting closest portions of the adjacent holes 211 to each other. Thus, a portion of the base plate 21 having the lowest strength can be reinforced by the rib 213, resulting in increase in the strength of the base plate 21. Consequently, deformation of the base plate 21 can be prevented which is caused by impact applied from the outside and resonance with various vibrations.

In this manner, in this preferred embodiment, the strength of the base plate 21 can be increased while the axial thickness of the base plate 21 and that of the motor 1 are reduced. Therefore, the motor 1 of this preferred embodiment is especially suited as a driving source of a disk drive for which a demand for reducing an axial size exists.

From a viewpoint of further increasing the strength of the base plate 21, it is preferable to provide the ribs 213 on the base plate 21 in three or more of the regions between the holes 211. In this preferred embodiment, the ribs 213 are provided in all regions between the holes 211, as described above. Therefore, the strength of the base plate 21 can be further increased.

In the motor 1 of this preferred embodiment, a plurality of ribs 213 can be easily formed integrally with the base plate 21 because they are formed by pressing when the base plate 21 is formed by pressing, as described above. Moreover, when the ribs 213 have a straight shape having a predetermined width over their entire length, a highly rigid projection can be easily obtained on the base plate 21.

In the motor 1 of this preferred embodiment, lower portions of the coils 242 are received in the holes 211, respectively. Thus, the motor 1 can be made slim in the axial direction. However, since the base plate 21 has the holes 211, the strength of the base plate 21 is low, as compared with a base plate with no hole. For this reason, the base plate 21 having the rib 213 for reinforcing the strength of the base plate 21 is especially-suited as a base plate having a hole for receiving a portion of each coil and a motor having such a base plate.

In this preferred embodiment, the rib 213 is formed prior to formation of the holes 211. That is, the strength of the base plate 21 is reinforced prior to formation of the holes 211. Thus, deformation of the base plate 21 when the holes 211 are formed can be surely prevented. Moreover, when pressing is carried out for the base plate 21 after the holes 211 are formed, it is possible to surely prevent a portion of the base plate 21 near the holes 211 from being pulled and deformed by drawing or the like.

If the ribs reach below the magnet for generating a magnetic field and the base plate with the ribs is made of magnetic material, a magnetic force acts between the ribs and the magnet and may cause various problems, e.g., lowering of the motor torque, and an unstable operation of the motor. Examples of the unstable operation of the motor are Repeatable Run Out (RRO) caused by vibration of the teeth, and Puretone (i.e., an unfavorable sound generated by resonance of a stator and a rotor or the like). That is, the motor performance is lowered. However, in this preferred embodiment, the center-axis side end of the rib 213 is located outside the outer surface of the magnet 34 in the radial direction. Therefore, it is possible to prevent lowering of the motor performance caused by interference of the rib 213 with the magnet 34.

### Second Preferred Embodiment

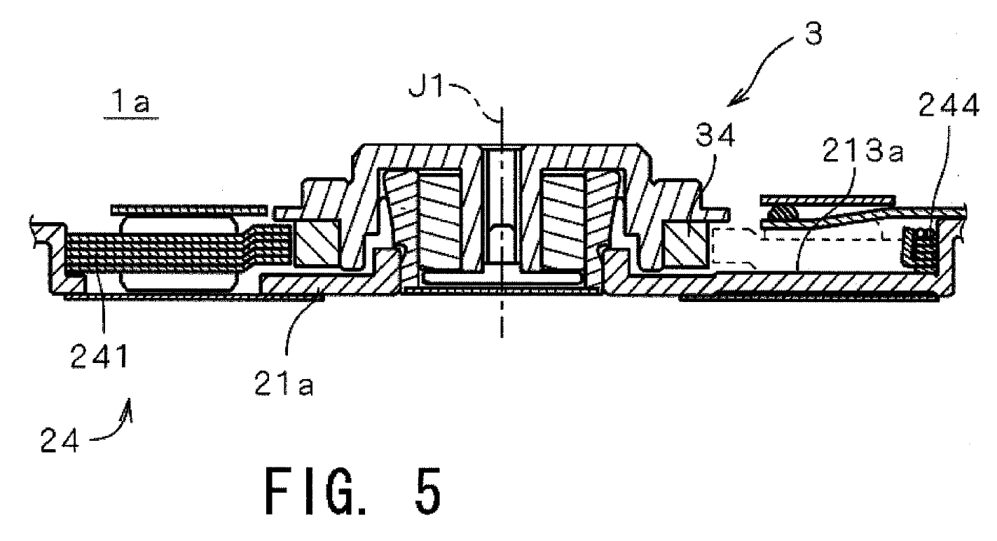

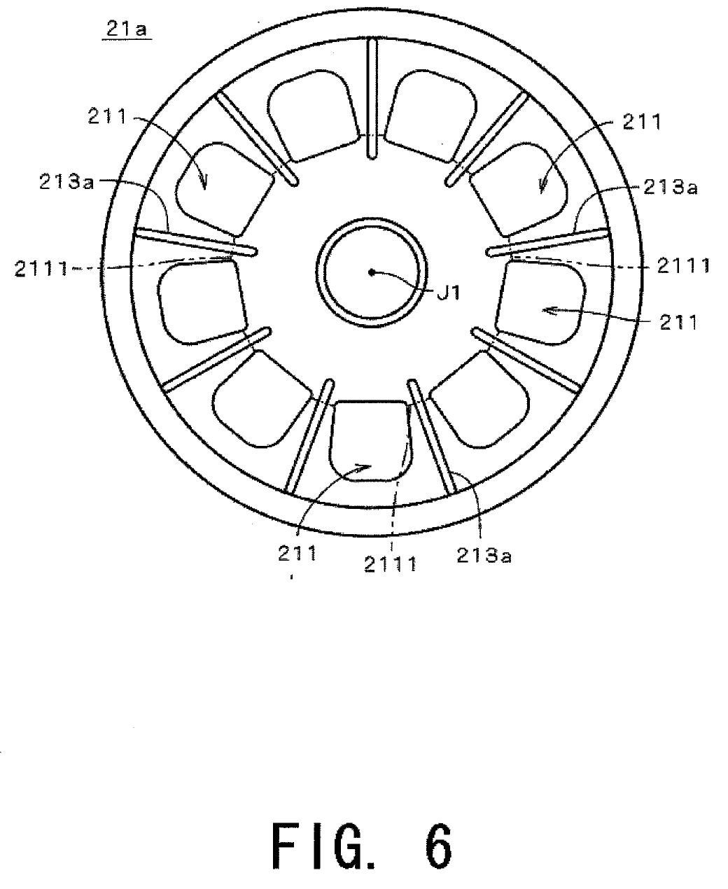

A motor according to a second preferred embodiment of the present invention is now described. FIG. 5 is a vertical cross-sectional view of the motor la of the second preferred embodiment. FIG. 6 is a plan view of a base plate 21a of the motor 1a. As shown in FIGS. 5 and 6, the base plate 21a in the motor 1 is provided with a plurality of ribs 213a having a different length from that of the rib 213 of the motor 1 shown in FIG. 4. Moreover, no armature supporting portion 214 is provided in the base plate 21a. Except for the above, the structure of the motor la is the same as that of the motor 1 shown in FIGS. 1 to 4. Therefore, like parts are given like reference numerals in FIGS. 5 and 6.

Referring to FIG. 6, the base plate 21a has the ribs 213a in all regions between the holes 211, as in the first preferred embodiment. The ribs 213a project from the upper surface of the base plate 21a toward the armature 24 (see FIG. 5). In this preferred embodiment, nine ribs 213 are provided in all nine regions between the holes 211, and are formed by pressing when the base plate 21a is formed by pressing, prior to formation of the holes 211.

The rib 213a extends straight generally in the radial direction and has a predetermined width over its entire length. Moreover, the rib 213a is arranged to cross the line 2111 which connects closest portions of adjacent holes 211 to each other, approximately perpendicularly thereto. As shown in FIG. 5, center-axis side ends of the ribs 213a are located outside the outer side surface of the magnet 34 of the rotor portion 3 in the radial direction.

As shown in FIG. 6, in the base plate 21a of this preferred embodiment, the ribs 213a extend to the radial outside of a circle centered on the center axis J1 and passing through outermost portions of the holes 211. The radially outer ends of the ribs 213a, i.e., the opposite ends to the center-axis side ends are located axially below the core back 244 of the stator core 241, as shown in FIG. 5. In the motor la, the lower surface of the core back 244 (i.e., the base plate side surface of the core back 244) is in contact with the ribs 213a. Thus, the armature 24 attached to the base plate 21a is supported from below.

In the motor la of this preferred embodiment, the ribs 213a are formed on the base plate 21a by pressing, as in the first preferred embodiment. Thus, it is possible to increase the strength of the base plate 21a while reducing the axial thickness of the base plate 21a and the motor 1a. Moreover, in this preferred embodiments it is possible to easily form a plurality of ribs 213a integrally with the base plate 21a.

In the motor 1a, the armature 24 is supported by the ribs 213a. In other words, the ribs 213a have a function of supporting the armature 24. Thus, the structure of the base plate 21a can be simplified.

### Third Preferred Embodiment

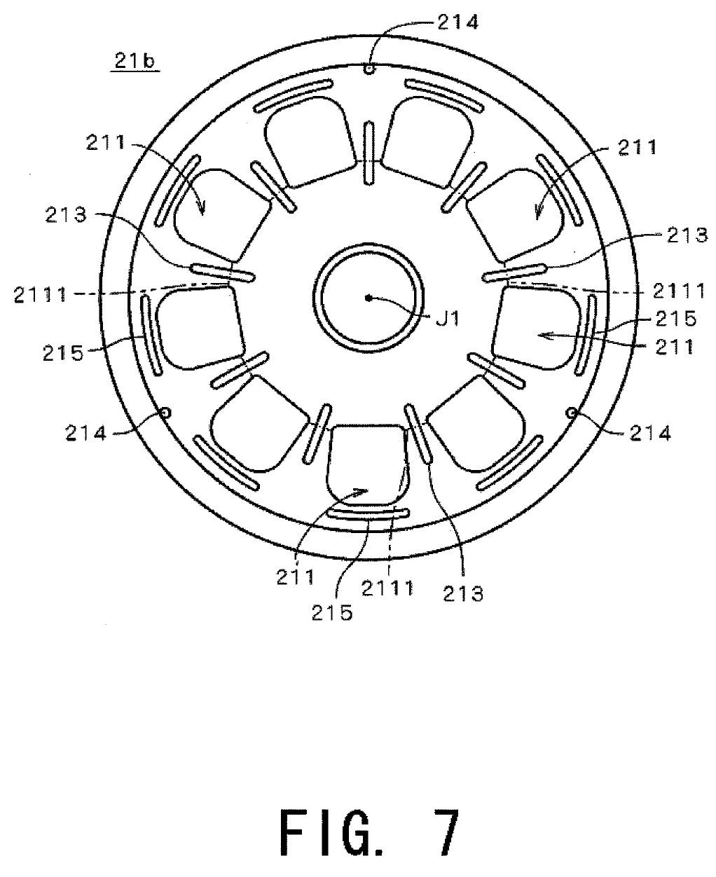

A motor according to a third preferred embodiment of the present invention is now described. FIG. 7 is a plan view of a base plate 21b of the motor of the third preferred embodiment. As shown in FIG. 7, the base plate 21b is provided with other convex portions 215 extending generally along a circumferential direction about the center axis J1, in addition to the ribs 213 shown in FIG. 4. As the other convex portions 215, ribs are provided. In this preferred embodiment, nine ribs 215 are provided. In the following description, the ribs 213 and 215 are distinguished from each other by using the terms “the first ribs 213” and “the second ribs 215”. Except for the above, the structure of the motor in this preferred embodiment is the same as that in the first preferred embodiment. Therefore, like parts are given like reference numerals in FIG. 7.

As shown in FIG. 7, the first ribs 213 cross the line 2111 generally perpendicularly there to as in the first embodiment. Please note that the line 2111 connects closest portions of adjacent holes 211 to each other. Each second rib 215 projects toward the armature 24 (see FIG. 2), and extends along a radially outer edge of a corresponding one of the holes 211 when seen in the axial direction. Both the first ribs 213 and the second ribs 215 are formed by pressing when the base plate 21b is formed by pressing, prior to formation of the holes 211.

In the motor of this preferred embodiment, the first ribs 213 are formed on the base plate 21b by pressing, as in the first preferred embodiment. Thus, it is possible to make the base plate 21b (and the motor including the base plate 21b) thin in the axial direction and increase the strength of the base plate 21b at the same time. Moreover, the first ribs 213 can be easily formed integrally with the base plate 21b.

In addition, the second ribs 215 extending along the outer edges of the corresponding holes 211, respectively, are formed on the base plate 21b in addition to the first ribs 213, in this preferred embodiment. Thus, the strength of the base plate 21b can be further reinforced. When the base plate 21b is manufactured, the first and second ribs 213 and 215 are formed prior to formation of the holes 211. Thus, deformation of the base plate 21b during formation of the holes 211 can be prevented more reliably.

In the motor of this preferred embodiment, the second ribs 215 of the base plate 21b are in contact with the lower surface of the core back 244 (see FIG. 3) of the stator core 241, so that the second ribs 215 support the armature 24. Therefore, the armature supporting portion 214 can be eliminated from the base plate 21b. This simplifies the structure of the base plate 21b.

The second ribs 215 may be formed to extend along radially inner edges, i.e., center-axis side edges of the holes 211. In this case, the second ribs 215 are located below the center-axis side edges of the teeth 243 (see FIG. 2).

### Fourth Preferred Embodiment

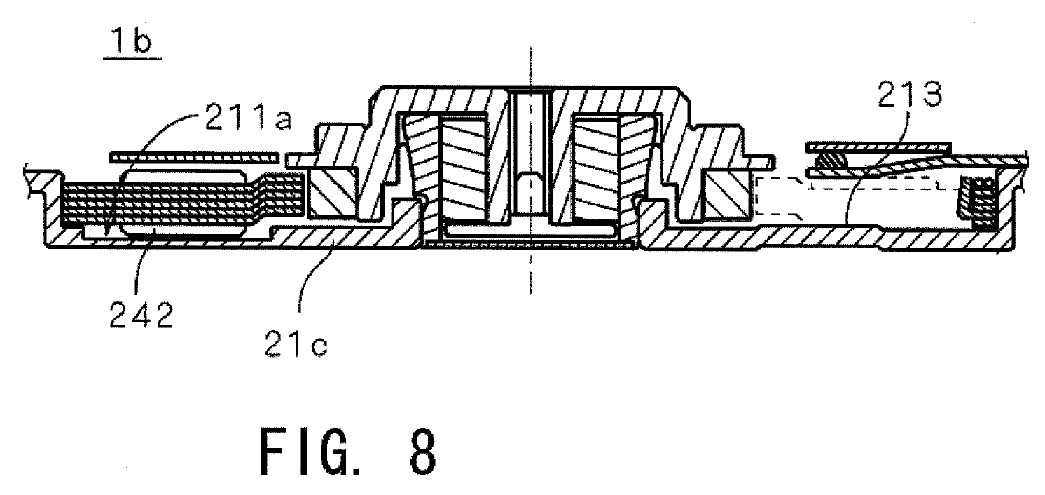

A motor according to a fourth preferred embodiment of the present invention is now described. FIG. 8 is a vertical cross-sectional view of the motor 1b according to the fourth preferred embodiment. As shown in FIG. 8, a base plate 21c of the motor 1b includes a plurality of recesses 211a, in place of the holes 211 shown in FIG. 2. Portions of the coils 242 are received in the corresponding recesses 211a. Except for the above, the structure of the motor 1b is the same as that in the first preferred embodiment. Like parts are given like reference numerals in FIG. 8.

The base plate 21c of the motor 1b also includes the ribs 213 between the recesses 211a. Each rib 213 crosses a line which connects closest portions of adjacent recesses 211a to each other, generally perpendicularly thereto. The ribs 213 are formed by pressing, as in the first preferred embodiment. Thus, it is possible to make the base plate 21c and the motor 1b thin in the axial direction and increase the strength of the base plate 21c. Moreover, the ribs 213 can be easily formed integrally with the base plate 21c.

The preferred embodiments of the present invention are described above. However, the present invention is not limited thereto but can be modified in various ways.

In the motor 1 of the first preferred embodiment, it is not necessary that the ribs 213 are provided between every adjacent two holes 211. Instead, only three ribs 213 maybe provided on a circle centered on the center axis J1 at regular angular intervals, for example. This is the same in the second and third preferred embodiments. Similarly, only three ribs 213 may be arranged at regular angular intervals in the fourth preferred embodiment in such a manner that adjacent ribs 213 sandwich three recesses 211a therebetween.

When the base plate is manufactured in any of the above preferred embodiments, the ribs may be formed after the holes 211 or recesses 211a if the base plate has a sufficient level of strength. Moreover, it is not necessary that the base plate forms a portion of the first housing member 611 of the disk drive 60. For example, the base plate may be formed as a base bracket which is separate from the first housing member 611 and is then secured to the first housing member 611.

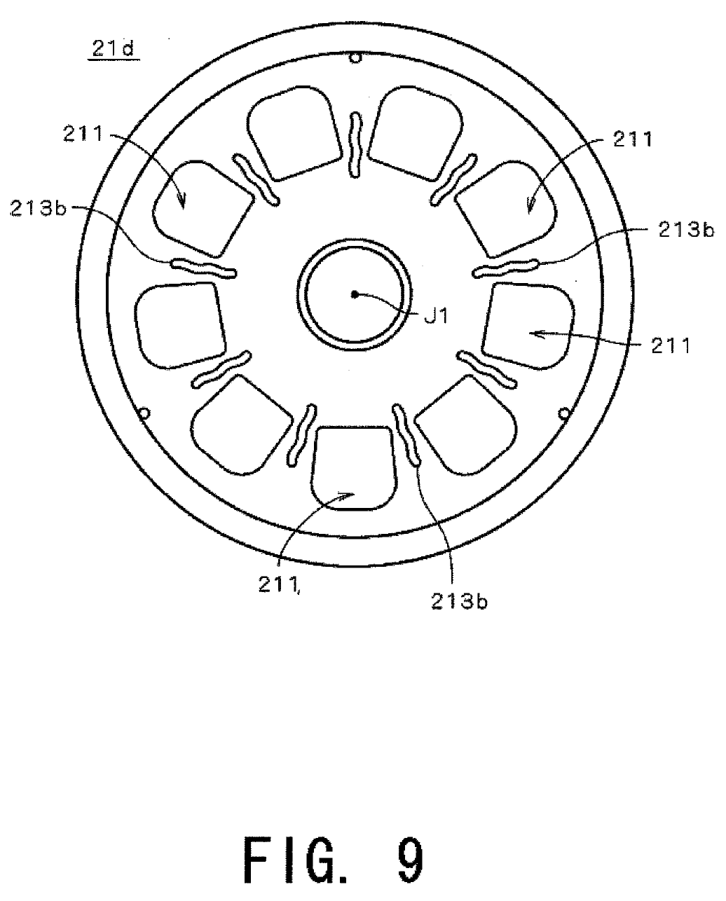

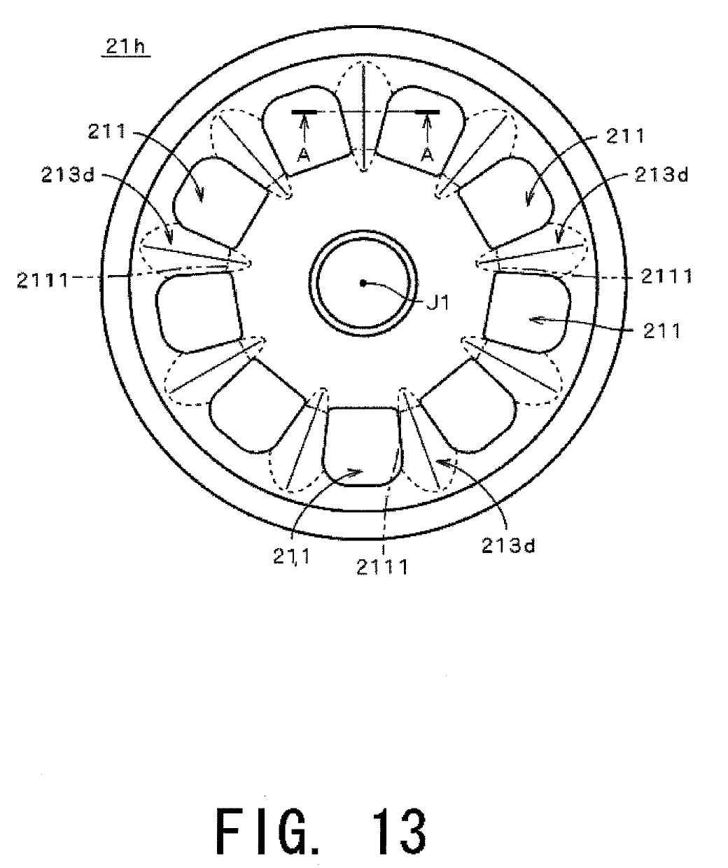

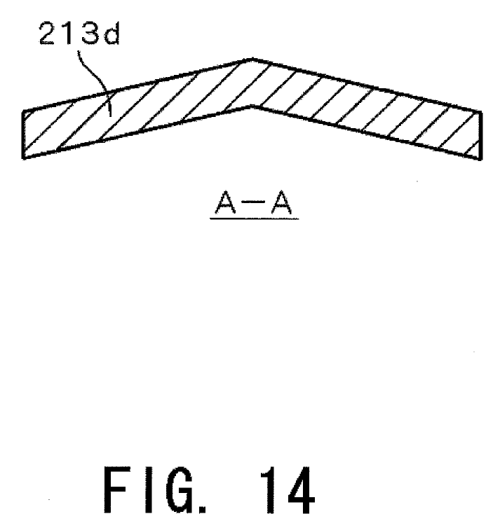

FIGS. 9, 10, 11, 12, and 13 are plan views of other preferred examples of the base plate. FIG. 14 is a cross-sectional view of a portion of the base plate 12h shown in FIG. 13, taken along line A-A in FIG. 13.

In the base plate 21d of FIG. 9, ribs 213b are provided to meander between every adjacent two holes 211. Each rib 213b extends approximately along the radial direction. The ribs 213b can increase the strength of the base plate 21d.

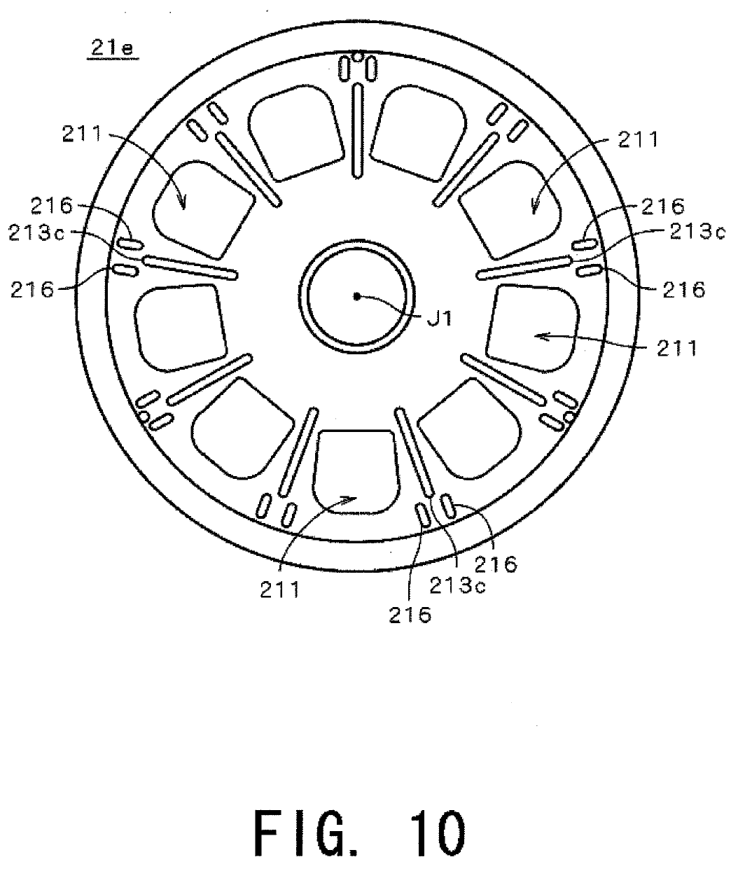

The base plate 21e of FIG. 10 is provided with a plurality of straight ribs 213c. The ribs 213c extend to a circle centered on the center axis J1 and passing through outermost portions of the holes 211. The rib 213c is provided between every adjacent two holes 211. The base plate 21e further includes outer ribs 216 which are provided outside the ribs 213c in the radial direction. Each outer rib 216 extends generally parallel to a nearest one of the ribs 213c. In the example of FIG. 10, two outer ribs 216 are provided near one rib 213. The ribs 216 are formed by pressing. In the base plate 21e, the strength of a region outside the holes 211 in the radial direction can be further reinforced by the outer ribs 216.

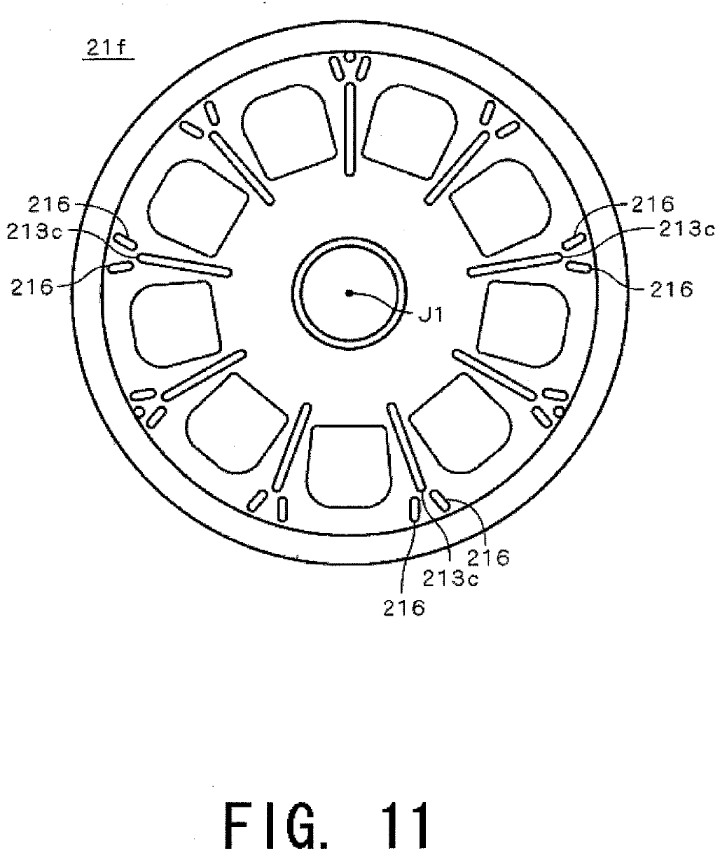

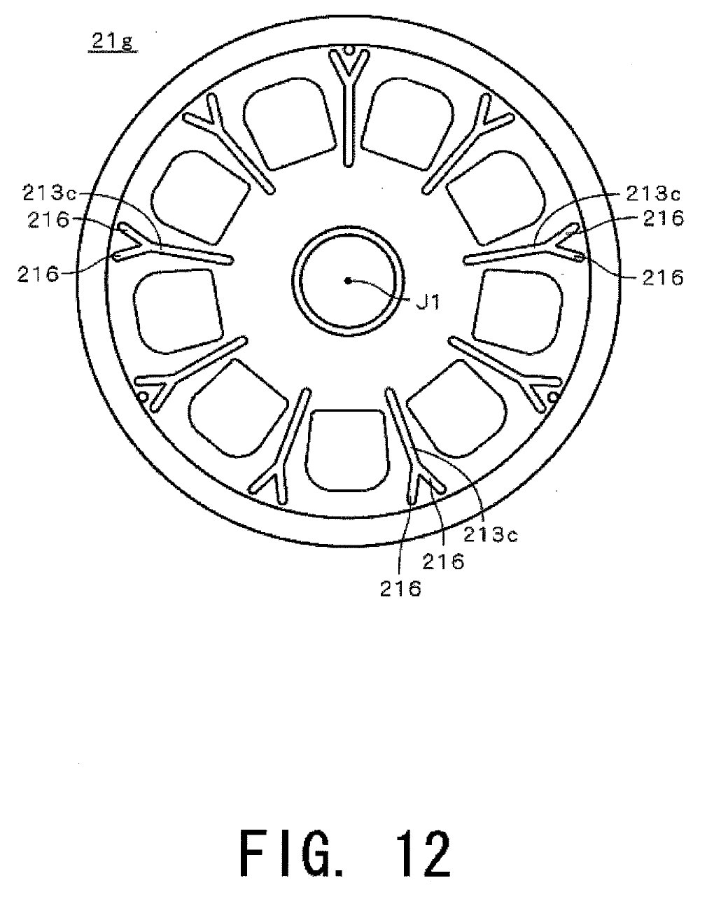

In the base plate 21f of FIG. 11, two outer ribs 216 associated with the same rib 213 are arranged outside that rib 213 to extend away from each other in a direction away from the center axis J1. In other words, two outer ribs 216 associated with the same rib 213 are not parallel to each other. The two outer ribs 216 may be connected at their center-axis side ends to the outer ends of the ribs 213c, as shown in FIG. 12.

In the base plate 21h shown in FIGS. 13 and 14, a portion 213d between adjacent two holes 211 is bent upward (i.e., toward the armature 24 (see FIG. 2)), for example, by pressing. The portions 213d serve as convex portions which are convex toward the armature 24, in place of the ribs in the aforementioned preferred embodiments.

The convex portions 213d are formed to cross the line 2111 connecting the closest portions of the adjacent holes 211 to each other, generally perpendicularly to the line 2111, as shown in FIG. 13. Thus, as in the first through fourth preferred embodiments, the thickness of the base plate 21h (and a motor including the base plate 21h) in the axial direction is reduced while the strength of the base plate 21h is reinforced.

The motors of the first through fourth preferred embodiments are not necessarily an inner rotor type in which the magnet 34 is arranged radially inside the armature 24. Instead, the motors of those preferred embodiments may be an outer rotor type in which the magnet 34 is arranged radially outside the armature 24. In this case, the center-axis side ends of the ribs arranged between the holes 211 or recesses 211a on the base plate are located axially below an annular core back which connects center axis side ends of a plurality of teeth.

The aforementioned motors may employ a so-called air dynamic pressure bearing which uses air as operating fluid, for example. Moreover, it is not necessary that a bearing assembly in the aforementioned motors uses a dynamic pressure of fluid. For example, a ball bearing may be used.

The disk drive 60 including any of the aforementioned motors can be used for driving disk-shaped storage media other than the magnetic disk described above, such as an optical disc and a magnetooptical disc. Moreover, the aforementioned motors can be also used in various devices other than disk drives.

As described above, according to the preferred embodiments of the present invention, it is possible to achieve reduction in the axial thickness of the base portion and increase in the strength of the base portion at the same time.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A motor comprising:
a stationary portion including an armature and a base portion to which the armature is attached; and
a rotor portion supported by a bearing assembly in a rotatable manner about a center axis relative to the stationary portion, the rotor portion including a magnet interacting with the armature to generate a torque about the center axis, wherein
the armature includes a stator core having a plurality of teeth radially disposed about the center axis, and a plurality of coils formed by winding a conductive wire around the teeth,
the base portion has a plurality of coil-receiving portions in regions corresponding to the coils, respectively, each of the coil-receiving portions receiving a portion of a corresponding one of the coils, and
the base portion has a projection projecting toward the armature, the projection is arranged between adjacent two of the coil-receiving portions, extends generally in a radial direction perpendicular to or substantially perpendicular to the center axis, and crosses a line connecting closest portions of the adjacent two coil-receiving portions to each other.

2. A motor according to claim 1, wherein the projection is a rib extending straight and having a predetermined width over its entire length.

3. A motor according to claim 1, wherein the projection is provided in each of three or more of regions between the coil-receiving portions.

4. A motor according to claim 3, wherein the projection is provided between every adjacent two of the coil-receiving portions.

5. A motor according to claim 1, wherein a base-portion side surface of the stator core is in contact with the projection.

6. A motor according to claim 1, wherein the base portion and the projection are integrally formed with each other as a single pressed member.

7. A motor according to claim 6, wherein the projection is formed prior to formation of the coil-receiving portions.

8. A motor according to claim 1, wherein the magnet is located on a center-axis side of the armature and
a center-axis side end of the projection is located outside of an outer surface of the magnet in the radial direction.

9. A motor according to claim 1, wherein the base portion has another projection which extends generally along a circumferential direction about the center axis and along an edge of one of the coil-receiving portions.

10. A motor according to claim 9, wherein the base portion, the projection, and the other projection are integrally formed with one another as a single pressed member.

11. A motor according to claim 1, wherein the coil-receiving portions are one of holes and recessed portions.

12. A disk drive comprising:
the motor according to claim 1 operable to rotate a disk-shaped storage medium capable of storing information;
a head operable to carry out at least one of reading information from and writing information on the disk-shaped storage medium; and
a head moving portion operable to move the head relative to the motor and the disk-shaped storage medium.
